(19) United States
(12) Patent Application Publication
(10) Pub. No.: US 2011/0305570 A1
(43) Pub. Date: Dec. 15, 2011

(54) AERODYNAMIC DEAD ZONE-LESS TRIPLE ROTORS INTEGRATED WIND POWER DRIVEN SYSTEM

(76) Inventors: Chan Shin, Seoul (KR); Ike Shin, Seoul (KR)

(21) Appl. No.: 13/158,362

(22) Filed: Jun. 10, 2011

Related U.S. Application Data
(60) Provisional application No. 61/353,679, filed on Jun. 11, 2010.

(51) Int. Cl. F03D 11/00

(52) U.S. Cl. 416/33

(57) ABSTRACT

The present invention relates to an aerodynamic dead zone-less triple-rotor integrated wind power driven system wherein control rotor 81 disposed at up-wind is rotated at a high speed. It induced the air flowing into the hub of extenders 71 of the auxiliary rotor 71 to the outside of the extenders 71-1 of the auxiliary rotor 71, thereby forming an aerodynamic annular stream tube zone and increasing the air density therein, the main rotor 11 disposed at down-wind, is aerodynamically accelerating and improving the system efficiency. In addition, the rotor 52 and stator 51 of the electromagnetic attraction dragging rotational torque of the auxiliary generator by the load assists to rotate main rotor 11, thereby the triple rotors integrating rotational torque generates the twin generators 4 and 4-1″ of the wind turbine.

### CROSS-REFERENCE TO RELATED APPLICATIONS

This application claims the benefit of U.S. Provisional Application No. 61/353,679 filed Jun. 11, 2010, which is incorporated herein in its entirety.

### FIELD OF THE DISCLOSURE

The present invention relates generally to a wind turbine system for generating electricity and more specifically to a wind turbine system for generating electricity that includes two up-wind rotors and one down-wind rotor structure.

### BACKGROUND OF THE INVENTION

Existing large scale wind turbine systems for utilizing wind energy to generate electricity have certain disadvantages.

For example, when the diameter of a wind turbine rotor exceeds twelve (12) meters, the wind input at its center has no effect on the rotation of the rotor thereby creating “an aerodynamic dead zone.” Accordingly, a large scale wind turbine system has its corresponding large aerodynamic dead zone.

Another disadvantage involves the coupling the rotational forces of two or more rotors with different RPMs, where the force generated is limited by the gear ratio of each rotor's RPM and the total rotational force is decreased by the drag force created between the rotors of different tip speed rotor.

Furthermore, when the input wind speed is above the rated wind speed, a mechanical stress can be created that exceeds the point where the wind turbine system can operate safely without breaking.

Another challenge to a developer of a wind turbine system is avoiding aerodynamic interference between the counter-rotating rotors.

### SUMMARY OF THE INVENTION

Accordingly, it is an object of the present invention to provide an improved wind turbine system for generating electricity.

Another object of the present invention is to provide a high speed small control rotor placed in front of auxiliary rotor in an up-wind position to create an aerodynamic dead zone-less system.

The control rotor increases the rotational speed of both auxiliary rotor in the up-wind position and main rotor in the down-wind position during low wind speed as well as during rated wind speed.

Another object of the present invention is to provide a flexible electromagnetic torque coupling where the rotational force of two or more rotors of different RPM is not limited by the gear ration of the RPMs of each rotors.

When the tip speed ratio of each rotors are different, rotation of one rotor acts as a drag force on each other thereby decreasing the total rotational force. Coupling of electromagnetic torque of the current invention is flexible and is not dependent on the gear ratio of the rotors and the drag force created by the different tip speed is avoided.

Further, the present invention is can operate under variable system capacity (i.e. variable load) corresponding to different input wind energy.

The variable system capacity improves the generators efficiency through the load share ratio of a large-sized generator in accordance with the magnitudes of the energy caused by the variation of input wind speed.

Other objects and the scope of applicability of the present invention will become apparent from the detailed description given hereinafter. It should be understood, however, that the detailed description and the specific examples, while indicating preferred embodiments of the invention, are given by way of illustration only since various changes and modifications within the spirit and scope of the invention will become apparent to those skilled in the art from this detailed description.

### BRIEF DESCRIPTION THE DRAWINGS

The present invention will become more fully understood from the detailed description given herein below and the accompanying drawings which are given by way of illustration only, and thus are not (imitative of the present invention, and wherein:

FIG. 1 is a perspective view of a wind turbine system embodying the present invention.

FIG. 2 is a side view of the annual stream tube depicting in detail the present invention.

FIG. 3 is a side view of gear box with its twins generators.

FIG. 4 is a detailed view of the section along the A-A′ or C-C′ line of the dual input gear box shown in FIG. 7.

FIG. 5 is a side view of the auxiliary generator.

FIG. 6 is a cross sectional view along B-B′ line shown in FIG. 5.

FIG. 7 is a side view of the dual axis inputs gear box.

FIG. 8 is a detailed view of the section along the D-D′ line shown in FIG. 7.

FIG. 9 is a side view of the rotor hub, the control rotor, and the auxiliary rotor.

### DETAILED DESCRIPTION OF THE INVENTION

### Triple Rotor System

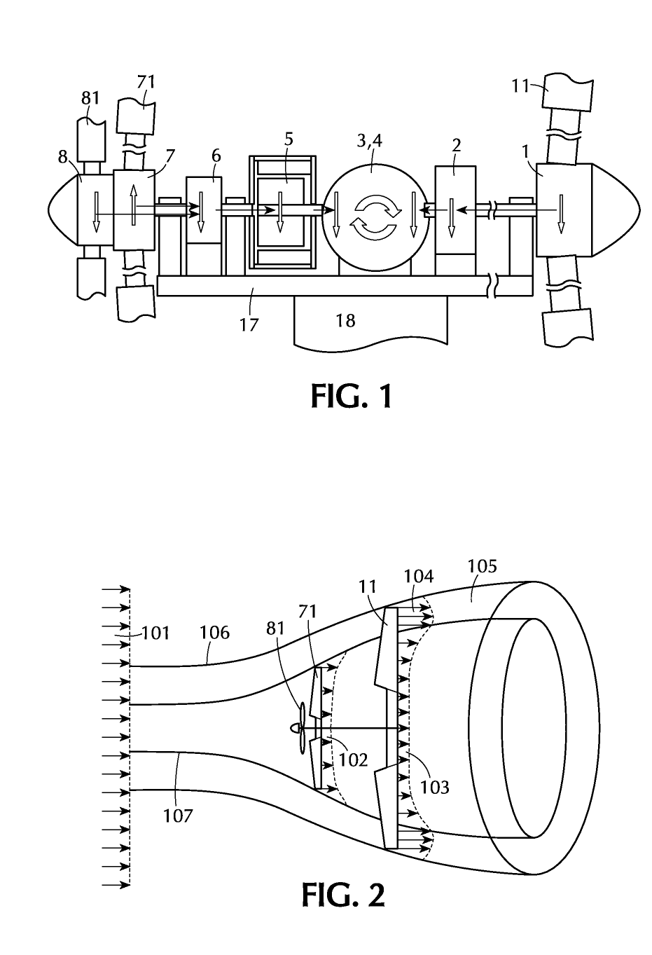

FIG. 1 shows overall system of the present invention. The present invention can be divided into seven parts. Part 1 in a down wind position comprises of main rotor 11 (“MR”) and its hub 1. Part 2 comprises of a gear box 2 which increases the speed of MR 11. Part 3 comprises of a gear box 3 which combines the rotational forces of control rotor 81 (“CR”), auxiliary rotor 71 (“AR”) and MR 11.

Part 4 comprises of twin generators 4, 4-1. Part 5 comprises of the auxiliary generator 5 which combines rotational forces of CR 81 and AR 71. Part 6 comprises of dual axis input gear box 6 which combines the rotational forces of CR 81 and AR 71. Part 7 comprises of CR hub 7 and AR hub 8 in a up wind position.

### Aerodynamic Dead Zone

A wind turbine obtains its power input by converting the force of the wind into a torque on the rotor blades. The amount of energy which the wind transfers to the rotor depends on the density of the air, the rotor area, and the wind speed.

The kinetic energy of a moving body is proportional to its mass or weight. The kinetic energy in the wind thus depends on the density of the air. In other words, the “heavier” the air, the more energy is received by the turbine.

At normal atmospheric pressure and at 15 Celsius air weighs some 1.255 kg per cubic meter. The greater the diameter of a wind turbine rotor, the greater the effect of tip speed to limit and reduce revolutions per minute (“RPM”). This creates an “aerodynamic dead zone” in part of the hub where no lift force is generated due to its low RPM.

More specifically, the aerodynamic dead zone is about 30% of the blade from the center axis, which no wind energy can be converted into mechanical energy.

Fast spinning CR 81 is placed directly in front of AR 71 blade extender hubs so that the wind inputs into this aerodynamic zone of the AR blades extenders is diverted outside of the dead zone thereby increasing the air density and directing this increased air density to the tips of the AR blade where the sweeping speed is the greatest.

FIG. 2 shows an air stream line 107 of AR 71 according to Betz's disk analogy model. Then an annular stream tube 104 with increased air density is created between an air stream line 107 of AR 71 and air stream line 106 of MR 11. Then, this increased air density of annular stream tube 104 is applied to the outer tips of MR 11 blades.

This phenomenon depends on the diameter of CR 81, the distance between CR 81 and AR 71, the diameter of AR 71, and the distance between AR 71 and MR 11. This phenomenon has been tested and proved numerous times with smaller model in a experimental field tests as well as actual sized scaled model field tests.

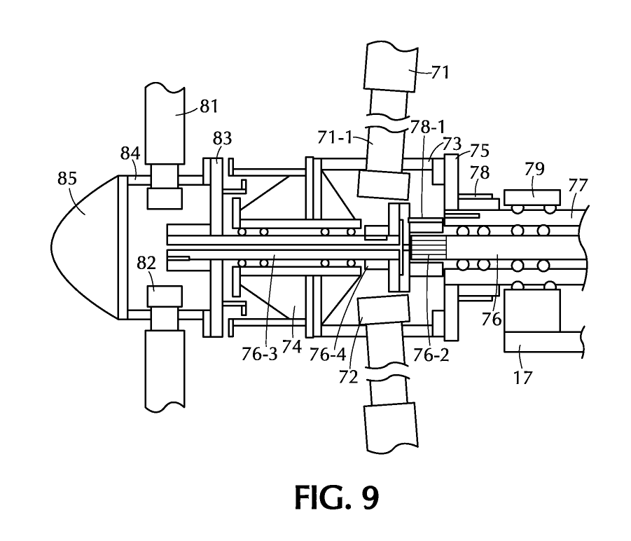

FIG. 1 shows the direction of rotation of each part indicated by the big arrows, and the direction of rotational force indicated by the small arrows. Keeping CR 81, AR 71 and MR 11 rotational force combining gear box 3 as the point of reference, will describe in order the upwind portion starting with FIG. 9 toward the gear box 3, then downwind portion starting with MR 11 towards the gear box 3.

When there is wind speed 1.8-2.2 m/s, CR 81 rotates in the direction as shown in FIG. 1. As shown in FIG 9, when CR 81 rotates, it causes the hollow shaft 76-3, the coupling plate 76-4 and the spline coupling 76-2 to rotate in the same direction.

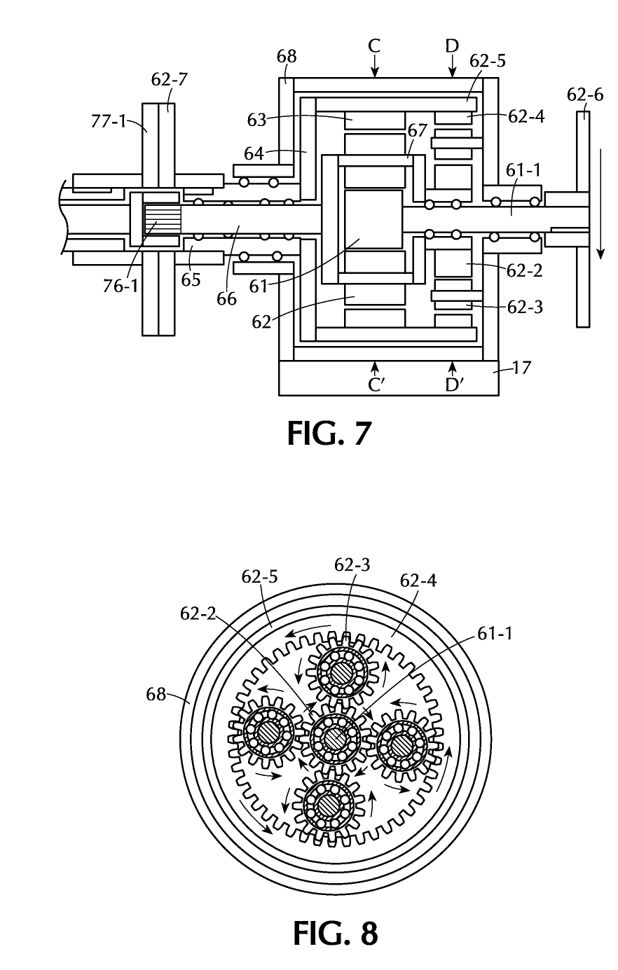

Then in FIG 7, this rotational force of CR 81 further extends and rotates rotational shaft 76 and spline coupling 76-1. This rotational force is transferred then to the CR-AR dual axis input gear box 6 where it rotates the input rotation shaft 66 and the Input member planet gear carrier 67.

As shown in FIG. 8, the second sun gear 62-2 attached to the input member planet gear carrier 67 will also rotate. This will rotate the second planet gears 62-3 and the second ring gear 62-4 in the opposite direction.

As CR 81 starts to rotate the second sun gear 62-2 attached to the input member planet gear carrier 67 also rotates. This sun gear 62-2 rotation will cause to counter rotate the second ring gear 62-4 which is attached to the second ring gear cylinder 62-5. Since the second ring gear cylinder 62-5 is coupled to AR 71, CR 81 rotation will eventually make AR 71 rotating in the opposite direction of CR 81.

Hence, the rotational force of CR 81 transfers to AR 71 adds to the direct natural wind input and assist AR 71 rotate more easily. The inverse rotational forces of these two rotors CR 81 and AR 71 creates the air stream tube 105 as shown in FIG. 2 with its increased the air density. This increased air density is directed at the tips of MR 11 and assist MR 11 rotate even at a low wind speed.

### Dual Axis Inputs GearBox

As shown in FIG. 7, when the difference in the rotational force of CR 81 and AR 71 spinning in opposite direction is inputted into the dual axis inputs gearbox 6, then the ring gear 63 and the planet gear carrier 67 rotating in opposite direction will rotate the sun gear 61 in clockwise direction according to the given gear ratio.

CR 81 Input RPM: N1 X {1+(ZR1/ZS1)} (1)

AR 71 Input RPM: N2 X (ZR2/ZS2) (2)

Total RPM of Sun Gear output shaft 61-1:

Tn1n2=[N1 X {1+(ZR1/ZS1)}]+N2 X (ZR2/ZS2) (3)

ZS1: number of first sun gear teeth

ZS2: number of second sun gear teeth

ZR1: number of first ring gear teeth

ZR2: number of second ring gear teeth

Above equation (1) only applies when the RPMs of the sun gear 61 and the ring gear 63, and the input torque are same. Based on the characteristic of dual axis gearbox 6, the larger torque AR 71 s rotational speed and CR 81 s rotational speed are determined by the the gear ratio of the second sun gear 62-2 and the second ring gear 62-4.

In order to make CR 81 and AR 71 s tip speed ratio the same, the size of the CR 81, and the gear ratio of the second sun gear 62-2 and the second ring gear 62-4 are adjusted so that the speed of AR 71 rotation is optimized to increase the efficiency of the system at the dual axis inputs gearbox 6.

However, since CR 81 performs the pitch control at the wind speed greater than the rated wind speed, rotational speed of CR 81 acts as a drag force on the rotational speed of AR 71 through the second planetary gear assembly shown in FIG. 8 of the dual axis inputs gearbox 6.

This slows down the rotational speed of the rotor 53 of auxiliary generator 5, and weakens the electromagnetic torque of the rotating stator 51 thereby decreasing the rotational speed of the MR 11 allowing the overall system to operate more safely.

### Electromagnetic Torque

The rotational force of CR 81 and AR 71 combined at the dual axis inputs gearbox 6 is transferred via the high speed output shaft 61-1, the connection plate 62-6, and the connection plate 59-1 of the auxiliary generator 5 to the rotor 52 attached to the rotor shaft 53 thereby rotating the rotor 52 clockwise as shown in FIG. 6 and generating rated RPM in accordance with the pole numbers of the auxiliary generator 5.

Then the electromagnetic coupling torque of the load is created. This causes the slow rotating stator 51 that is rotating in the same direction as the high speed rotating rotor 52 to rotate in the same direction, thereby increasing the rotational speed of the MR 11.

This mechanism is summarized as follows:

Torque of CR 81+Rotational Torque of AR 71=generation power of the auxiliary generator 5

Electromagnetic torque from the load between the rotor 52 of the auxiliary generator 5 and the rotation stator 51+rotational torque of MR 11=generation power of the twins generators 4, 4-1

The general principle behind the generators is based on the rotational force created between the stator and the rotor. Energy is generated when one or other rotates or when they rotate in opposite direction to one another.

However, the generator of the present invention generates energy even though both the rotor and the stator are rotating in the same direction. The number of poles of auxiliary generator has a prescribed RPM's.

It is the difference of this prescribed RPM's in effect acts as though either the stator 51 or the rotor 52 is in a fixed position thereby generating energy. If the RPM of the rotor 52 is defined as V1, RPM of the stator 51 rotating in same direction is defined as V2, and the prescribed RPM of the number of poles of the auxiliary generator 5 is defined as V0:

V0=V1−V2 (4)

RPM of V2 is accelerated by predetermined number of rotation of MR 11's gearbox 2. This RPM V2 inputs to a horizontal input shaft 39 of CR-AR rotational force combining gearbox 3 which is coupled to the rotation stator 51. The energy generated from the auxiliary generator 5 is drawn out by the slip ring 54. And this energy also rotates the bearings 58, 55 which are mounted on the drive train pad 17 of the auxiliary generator 5.

### Total Rotational Force Integrating Gearbox

Rotational force generated by MR 11 and rotational force generated by the electromagnetic coupling torque created between rotor 52 and stator 51 of the auxiliary generator 5 by the load combined at the gearbox 3. As shown in FIG. 1, the rotational force of MR 11 is inputted into the gearbox 2 and generates energy based on a prescribed number of rotation.

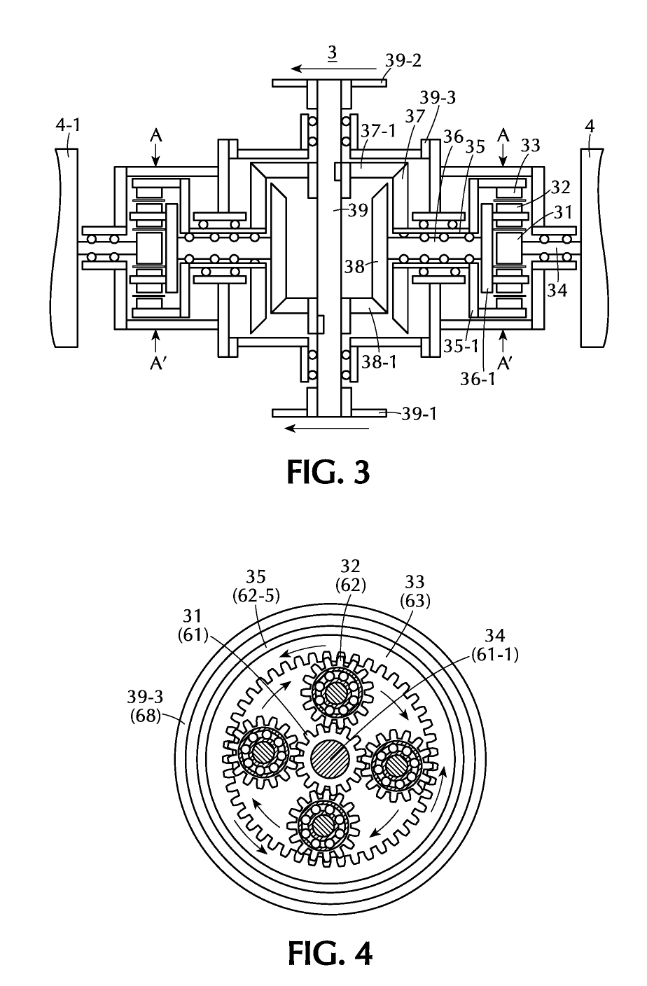

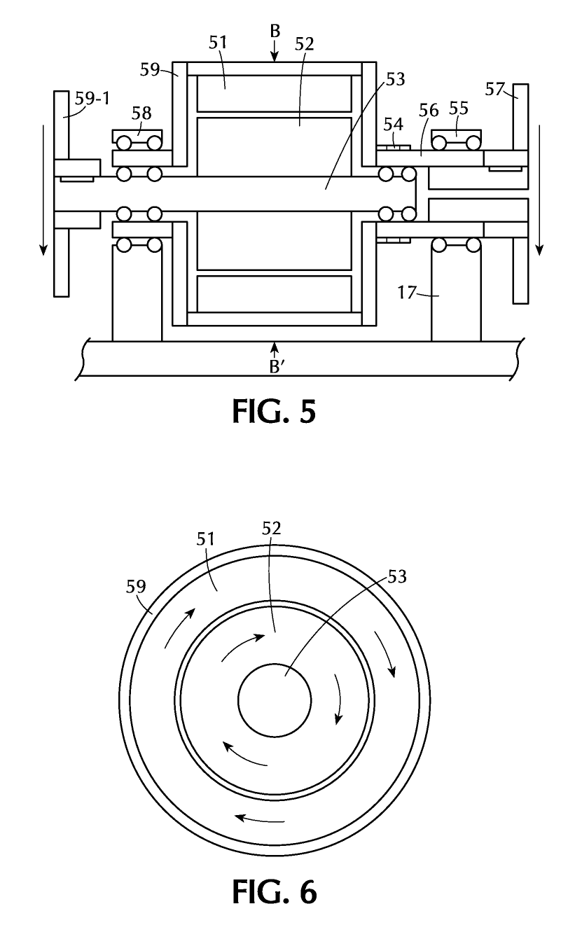

In FIG. 5, the rotational force generated by the combined electromagnetic coupling torque in the auxiliary generator 5 is transmitted via rotation shaft 56 and rotational plate 57. Then it is sent to the rotational force connection plate 39-2. Finally, these rotational force are combined at the horizontal input shaft 39 of the twins planetary gear of the gearbox 3 as shown in FIG. 3.

Such sun gear and planetary gear assembly is known from the Applicant's U.S. Pat. No. 5,876,181, the contents of which are hereby incorporated in their entirety.

In FIG. 3, the right-sided bevel gear 37-1 and left-sided bevel gear 38-1 rotates in the direction as indicated by the arrow. This causes the bevel gear 38 and the bevel gear 37 to rotate in opposite direction to one another.

Further, the bevel gear 38 is attached to the planet gear input shaft 36 on each twin planetary gear system. In each twin planetary gear system, the planet gear carrier 36-1, the ring gear cylinder input shaft 35 and the ring gear cylinder 35-1 are attached to the ring gear 33.

The ring gear 33 rotates in the opposite direction to the planet gears 32 as indicated by the arrows as shown in FIG. 4 thereby obtaining the gear ratio and the RPM as follows:

Z0={(1+ZR/ZS)+(ZR/ZS)}X n (5).

Z0 is the total output RPM

ZS is the number of sun gear teeth

ZR is the number of ring gear teeth

n is the input RPM

### Variable Load Capacity System

The sun gear 31 accelerated to the rated output RPM rotates the output shaft 34, thereby rotating the twin generators 4, 4-1. The gearbox 3 is a twin planetary gearbox system with symmetrical gearbox on either side of horizontal input shaft 39.

The rotational forces of MR 11, AR 71 and CR 81 are combined at this horizontal input shaft 39. Depending on the variable forces of the input wind energy, one or both generators can be operated.

When the input wind energy from cut-in wind speed is up to 10 m/s, about 60% of the full system is operated where the auxiliary generator 5 and the twin generator 4 operates. When the wind speed ranges from 10.1 m/s to rated wind speed of 12 m/s, the twins generator 4-1 is added to the auxiliary generator 5 and the twin generator 4.

Accordingly, the present invention includes the auxiliary generator's electromagnetic coupling torque, the triple rotor-irtegrating force, and aerodynamic dead zone-less wind power generating system, thereby increasing the system's potential capacity to a maximum degree and providing high efficiency aerodynamic operation.

No doubt many other effective alternatives will occur to the skilled person. It will be understood that the invention is not limited to the described embodiments and encompasses modifications apparent to those skilled in the art lying within the sprit and scope of the claims appended hereto.

1. A triple rotor wind turbine system comprising:
a control rotor, an auxiliary rotor, a main rotor, a first gear assembly wherein the control rotor and the auxiliary rotor are drivingly connected to the first assembly and being mounted for rotation about a common axis, the main rotor being disposed downwind of the control and auxiliary rotor, the first gear assembly including means for mechanically combining the each rotor's rotational forces to provide a combined rotational force, and a second gear assembly wherein an outer stator surrounds an inner rotor for allowing magnetically rotational movement relative to the outer stator and wherein the outer stator is rotationally coupled with the main rotor and the combined rotational force is rotationally coupled with the inner rotor so that the combined force cause the main rotor to begin to rotate at lower wind speed.

2. A triple rotor wind turbine system as defined in claim 1, wherein each of the rotor including a plurality of rotor blades, each of the blades having an innermost portion and a tip, the tips of the auxiliary rotor blades defining a first circle during rotation thereof, the innermost portion of the main rotor defining a third circle rotation thereof, the radius of the second circle being substantially equal to the radius of the first circle so that the main rotor blades are not disturbed by the wake of the auxiliary rotor blades.

3. A triple rotor wind turbine system as defined in claim 2, wherein the first circle generating an inner stream line thereof according to diagrammatic representation of Betz's disk analogy model, the third circle generating an outer stream line thereof according to Betz's disk analogy model, the distal end of the blades of the main rotor being disposed between the inner and outer stream lines in order to receive aggregated air density thereof so that the main rotor begins to rotate quickly at low wind speed.

4. A tripe rotor wind turbine system as defined in claim 1, wherein the first gear assembly comprises a control input shaft being driven by the control rotor, an common ring gear being coupled and driven by the auxiliary rotor, a combined output shaft, a first planetary gear carrier being driven by the control rotor, a first sun gear being coupled with the combined output shaft, the second planetary gear carrier being fixed to the gear assembly, the second sun gear being rotatably connected to the first planetary gear carrier so that as the control rotor begins to rotate the first planetary gear carrier accelerates the first sun gear and then rotate the common ring gear in the opposite direction thereby making the auxiliary rotor counter rotating relative to the control rotor.

5. A triple rotor wind turbine system as defined in claim 1, wherein the second gear assembly includes an inner rotor and an outer stator, the outer stator surrounding the inner rotor for allowing magnetically rotational movement relative to the stator in the same direction, the outer stator being coupled with the main rotor, the combined output shaft coupled with the inner rotor so that the slow rotating stator that is rotating in the same direction as the high speed rotating inner rotor to rotate in the same direction so that the electromagnetic attraction dragging torque between the inner rotor and the outer stator increases the rotational speed of the main rotor.

6. A triple rotor wind turbine system as defined in claim 2, wherein the rate of rotation of said auxiliary rotor blades is greater than the rate of rotation of the main rotor blades so that the tip speed ratio of the auxiliary rotor blades and said main rotor blades are substantially the same.

7. A dual rotor wind turbine system comprising:
an auxiliary rotor, a main rotor, a gear assembly wherein the auxiliary rotor and main rotor are drivingly connected to the assembly and being mounted for rotation about a common axis, the main rotor being disposed downwind of the auxiliary rotor, the gear assembly including means for magnetically causing the auxiliary rotor's rotational forces to increase the rotation of the main rotor so that the main rotor begins to rotate at lower wind speed.

8. A dual rotor wind turbine system as defined in claim 7, wherein each of the rotor including a plurality of rotor blades, each of the blades having an innermost portion and a tip, the tips of the auxiliary rotor blades defining a first circle during rotation thereof, the innermost portion of the main rotor defining a third circle rotation thereof, the radius of the second circle being substantially equal to the radius of the first circle so that the main rotor blades are not disturbed by the wake of the auxiliary rotor blades.

9. A dual rotor wind turbine system as defined in claim 8, wherein the first circle generating an inner stream line thereof according to diagrammatic representation of Betz's disk analogy model, the third circle generating an outer stream line thereof according to Betz's disk analogy model, the distal end of the blades of the main rotor being disposed between the inner and outer stream lines in order to receive aggregated air density thereof so that the main rotor begins to rotate quickly at low wind speed.

10. A dual rotor wind turbine system as defined in claim 7, wherein the gear assembly includes an inner rotor and an outer stator, the outer stator surrounding the inner rotor for allowing magnetically rotational movement relative to the stator in the same direction, the outer stator being coupled with the main rotor, the inner rotor being coupled with the auxiliary rotor so that the slow rotating stator that is rotating in the same direction as the high speed rotating inner rotor to rotate in the same direction so that the electromagnetic attraction dragging torque between the inner rotor and the outer stator increases the rotational speed of the main rotor.

11. A triple rotor wind turbine system as defined in claim 7, wherein the rate of rotation of said auxiliary rotor blades is greater than the rate of rotation of the main rotor blades so that the tip speed ratio of the auxiliary rotor blades and said main rotor blades are substantially the same.
